(19) United States
(12) Patent Application Publication
(10) Pub. No.: US 2017/0097404 A1
(43) Pub. Date: Apr. 6, 2017

(54) Methods and Apparatuses for Positioning in Network Cells Having Multiple Transmission Points

(71) Applicant: Telefonaktiebolaget LM Ericsson (publ), Stockholm (SE)

(72) Inventors: Iana Siomina, Täby (SE); Åke Busin, Sollentuna (SE)

(73) Assignee: Telefonaktiebolaget LM Ericsson (publ), Stockholm (SE)

(21) Appl. No.: 15/311,877

(22) PCT Filed: May 19, 2015
(86) PCT No.: PCT/SE2015/050555

§ 371 Date: Nov. 17, 2016

Related U.S. Application Data
(60) Provisional application No. 62/000,744, filed on May 20, 2014.

(51) Int. Cl. G01S 5/10; G01S 5/02; H04W 64/00

(52) U.S. Cl. CPC G01S 5/10; H04W 64/00; G01S 5/0236

(57) ABSTRACT

In one aspect of the teachings herein, a wireless communication network includes two or more radio transmission points sharing the same Physical Cell Identity, PCI, and the network provides a User Equipment, UE, with positioning assistance data indicating the muting patterns used by respective ones of the transmission points for transmitting Positioning Reference Signals, PRS. The respective transmission points sharing the same PCI both transmit PRS identified by the shared PCI, but the transmissions are differentiated as a consequence of the respective muting patterns. Correspondingly, the UE exploits the positioning assistance data from the network, to make PRS measurements that are differentiated with respect to the transmission points sharing the same PCI. Differentiating between PRS as received from the different transmission points sharing the same PCI yields more accurate positioning, whether the positioning is done by the UE, or by the network based on receiving measurements from the UE.

### RELATED APPLICATIONS

This application claims priority from U.S. provisional application 62/000,744, filed on May 20, 2014.

### TECHNICAL FIELD

The present invention generally relates to wireless communication networks and particularly relates to positioning operations with respect to network cells that include multiple transmission points having a common cell identifier.

### BACKGROUND

The Positioning Reference Signals, or PRS, used in cellular communication networks based on the Long Term Evolution, LTE, standards promulgated by the Third Generation Partnership Project, 3GPP, are associated with the Physical Cell Identity, PCI, of the radio node transmitting the PRS. PRS may be used, for example, for making various positioning-related measurements, such as making Reference Signal Time Difference, RSTD, measurements, e.g., Observed Time Difference of Arrival, OTDOA, measurements.

FIG. 1 illustrates an example transmission scheme for PRS from a given transmission port, for one and two Physical Broadcast Channel, PBCH, antennas. The PRS are transmitted from antenna port “R6” according to a pre-defined time/frequency pattern. In particular, the diagram depicts an example PRS pattern for LTE, where the R6 squares indicate resource elements used for PRS transmission, within a block of twelve Orthogonal Frequency Division Multiplexing, OFDM, subcarriers over fourteen OFDM symbols. Here, the subcarriers run along the vertical axis and the OFDM symbols run along the horizontal axis. The fourteen symbols are repetitively numbered l=0 through l=6, to denote two slots of a 1 ms subframe using a normal cyclic prefix.

A set of frequency shifts can be applied to the pre-defined PRS patterns to obtain a set of orthogonal patterns that can be used in neighbor cells to reduce interference on the PRS and thus improve positioning measurements. An effective frequency reuse of six can be modeled in this way. The frequency shift is defined as a function of the PCI. PRS can also be transmitted on a cell basis with zero power or with reduced power. These muting or PRS power control techniques represent mechanisms for reducing the interference caused to the PRS transmitted in one cell by the simultaneous PRS or other transmissions in neighboring cells.

In this regard, PRS are transmitted in pre-defined positioning subframes grouped by several consecutive subframes, N_{PRS}, i.e., one positioning occasion, which occurs periodically with a certain periodicity of N subframes. The periodicity defines the time interval between two positioning occasions and the defined periods for LTE are 160, 320, 640, and 1280 ms. The number of consecutive subframes N_{PRS} in each positioning occasion can be 1, 2, 4, or 6.

To improve PRS reception at the respective UEs, i.e., to allow for detecting PRS from multiple cells and at a reasonable quality, positioning subframes have been designed as low-interference subframes. In other words, it it has also been agreed that no data transmissions are allowed in general in positioning subframes. Consequently, in a synchronous network that adopts such an arrangement, PRS are ideally interfered only by PRS from other cells having the same PRS pattern index, i.e., same vertical shift, v_shift, and not by data transmissions in other cells.

Associating PRS to PCIs enables each item of User Equipment, UE, operating in the network to distinctly identify the radio nodes involved in given RSTD measurements. However, it is recognized herein that a number of PRS measurement scenarios are problematic. For example, a cell may use Remote Radio Heads, RRHs, for transmitting within the overall cell coverage area. More generally, whether or not used for Coordinated Multipoint, CoMP, transmissions, a given cell may include multiple, geographically separated transmission points and, in general, all such transmission points will share a common PCI. Thus, a UE cannot use PCI to distinguish between different radio nodes associated with the same PCI. As further recognized herein, failing to distinguish between transmission points sharing the same PCI when making PRS measurements will significantly deteriorate the resulting positioning accuracy.

### SUMMARY

In one aspect of the teachings herein, a wireless communication network includes two or more radio transmission points sharing a common cell identity, e.g., the same Physical Cell Identity, PCI, and the network provides a User Equipment, UE, with positioning assistance data indicating the muting patterns used by respective ones of the transmission points for transmitting Positioning Reference Signals, PRS. The respective transmission points sharing the same PCI both transmit PRS identified by the shared PCI, but the transmissions are differentiated as a consequence of the respective muting patterns. Correspondingly, the UE exploits the positioning assistance data from the network, to make PRS measurements that are differentiated with respect to the transmission points sharing the same PCI. Differentiating between PRS as received from the different transmission points sharing the same PCI yields more accurate positioning, whether the positioning is done by the UE, or by the network based on receiving measurements from the UE.

In an example embodiment, a method at a wireless device configured for operation in a wireless communication network includes receiving positioning assistance data for a cell of the wireless communication network that includes two or more geographically-separated transmission points sharing a common cell identity, such as the same PCI. The positioning assistance data indicates muting patterns used by respective ones of the two or more transmission points for transmitting positioning reference signals. The method further includes processing the positioning assistance data to extract the muting patterns, and measuring positioning reference signals from each of the two or more transmission points according to the muting patterns, to obtain positioning reference signal measurements that are differentiated with respect to the two or more transmission points. Additionally, the method includes performing at least one of: determining positioning information for the wireless device based on relating the differentiated positioning reference signal measurements; and reporting the differentiated positioning reference signal measurements to the wireless communication network.

In a related example embodiment, a wireless device is configured for operation in a wireless communication network and comprises a communication interface configured to receive signals from a wireless communication network and to send signals to the wireless communication network. The device further includes a processing circuit that is operatively associated with the communication interface and is configured to receive positioning assistance data for a cell of the wireless communication network that includes two or more geographically separated transmission points sharing a common cell identity, e.g., both transmission points are associated with the same PCI. The positioning assistance data indicates muting patterns used by respective ones of the two or more transmission points for transmitting positioning reference signals, and the processing circuit is configured to process the positioning assistance data to extract the muting patterns, measure positioning reference signals from each of the two or more transmission points according to the muting patterns, to obtain positioning reference signal measurements that are differentiated with respect to the two or more transmission points. The processing circuit is configured to perform at least one of: determining positioning information for the wireless device based on relating the differentiated positioning reference signal measurements; and report the differentiated positioning reference signal measurements to the wireless communication network.

In another example embodiment, a method of operation at a node configured for operation in a wireless communication network includes determining muting patterns used in a cell of the wireless communication network that includes two or more geographically-separated transmission points sharing a common cell identity. The muting patterns are used by respective ones of the two or more transmission points for transmitting positioning reference signals, and the method includes generating positioning assistance data for the cell, for a wireless device operating in the wireless communication network. The positioning assistance data indicates the muting patterns used by the two or more transmission points of the cell, and the method includes sending the positioning assistance data to the wireless device, thereby enabling the wireless device to make differentiated positioning reference signal measurements with respect to the two or more transmission points of the cell.

In a related embodiment, a node is configured for operation in a wireless communication network and includes a communication interface configured for directly or indirectly communicating with a wireless device operating in the wireless communication network. The node further includes a processing circuit that is operatively associated with the communication interface and is operative to enable positioning operations at the wireless device on a per transmission-point basis. This latter aspect of operability is based on the processing circuit being configured to determine muting patterns used in a cell of the wireless communication network that includes two or more geographically separated transmission points sharing a common cell identity. The muting patterns used by respective ones of the two or more transmission points are for transmitting positioning reference signals, and the processing circuit is configured to generate positioning assistance data for the cell, for use by the wireless device. The positioning assistance data indicates the muting patterns used by the two or more transmission points of the cell, and the processing circuit is configured to send the positioning assistance data to the wireless device, e.g., via the communication interface, thereby enabling the wireless device to make differentiated positioning reference signal measurements with respect to the two or more transmission points of the cell.

### BRIEF DESCRIPTION OF THE DRAWINGS

FIG. 1 is a diagram of a known Positioning Reference Signal, PRS, transmission pattern for one or two antennas.

FIG. 2 is a block diagram of one embodiment of a wireless communication network having one or more wireless devices and one or more other nodes configured according to the teachings herein.

FIG. 3 is a block diagram of one embodiment of a wireless device and another node, as configured according to the teachings herein, and as usable within the network of FIG. 2, for example.

FIG. 4 is a logic flow diagram for one embodiment of a method of processing at a node of determining and providing positioning assistance data that enables a wireless device to make differentiated measurements for positioning reference signals transmitted from different ones of two or more transmission points operated under the same cell identifier in a cell of a wireless communication network.

FIG. 5 is a logic flow diagram for one embodiment of a method of processing at a wireless device, for obtaining differentiated positioning reference signal measurements, with respect to two or more transmission points operated under a common cell identifier in a cell of a wireless communication network.

FIG. 6 is a block diagram of one embodiment of a processing circuit arrangement for a wireless device, for obtaining differentiated positioning reference signal measurements at a wireless device, which measurements are differentiated with respect to individual ones of two or more geographically separated transmission points operated under a common cell identifier in a cell of wireless communication network.

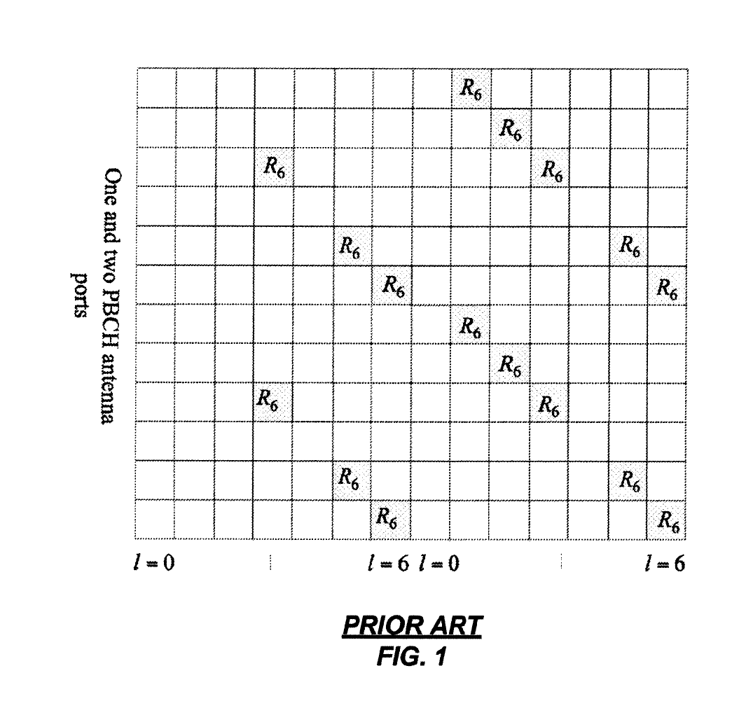

### DETAILED DESCRIPTION

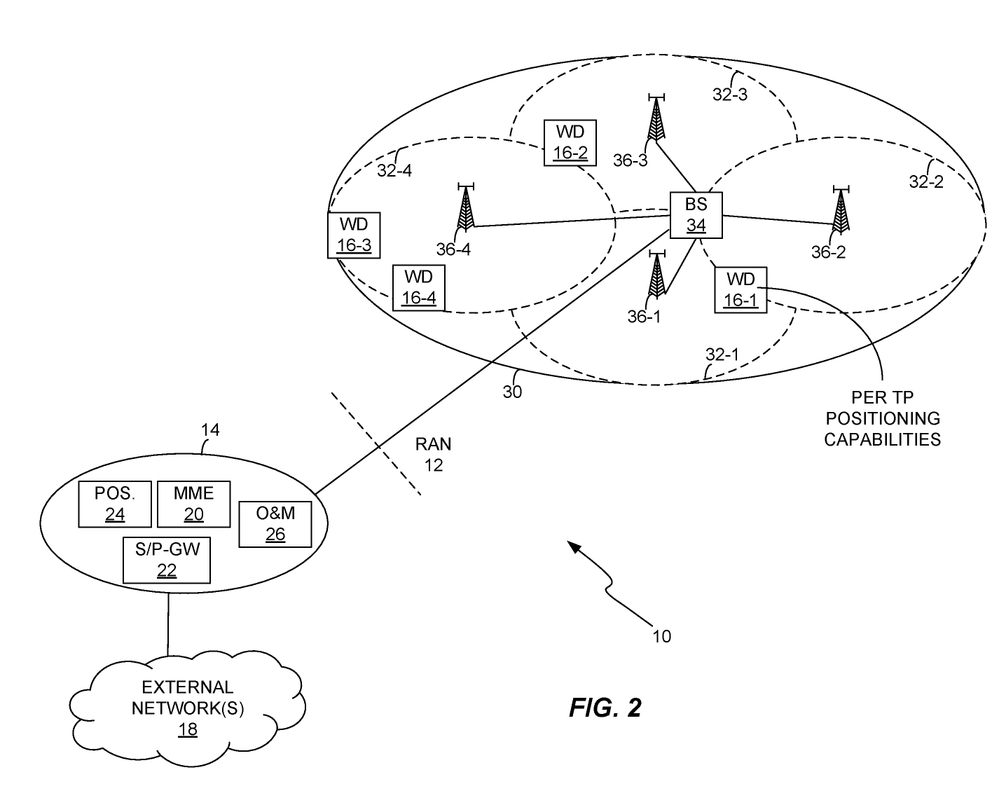

FIG. 2 provides a non-limiting example illustration of a wireless communication network 10, such as a WCDMA or LTE cellular communication network operating according to the applicable 3GPP specifications. The network 10 includes a Radio Access Network or RAN 12 and an associated Core Network or CN 14, and provides communication services to any number of wireless devices 16, by communicatively coupling the wireless devices 16 to one or more external networks 18, such as the Internet or other packet data networks.

Supporting its communications and control functionality, the illustrated CN 14 includes a Mobility Management Entity or MME 20, which provides bearer activation and mobility management functions for wireless devices 16, including Serving/Packet Gateway (S/P-GW 22) selection functions, etc. The CN 14 further includes a positioning node 24, such as an Enhanced Serving Mobile Location Center, E-SMLC, one or more Operations & Maintenance, O&M, nodes 26, etc. The CN 14 may also include Operations Support Systems, OSS, nodes, and other nodes and functions not illustrated here.

The illustrated RAN 12 includes a number of cells, with only one cell 30 illustrated for ease of illustration and discussion. The cell 30 can be understood as corresponding to a geographic coverage area supported by a given allocation of air interface resources—e.g., a given carrier frequency covering a given service area. As a non-limiting example, the same carrier frequencies can be used to define different cells in different geographic regions and/or different carrier frequencies can be used to define different, but possibly overlapping cells in the same region. Further, with beamforming and other techniques, cells or cell sectors can be defined by steering beam patterns, etc.

Of particular interest herein, the cell 30 uses a distributed antenna system or other technique to subdivide the cell 30 into different cell portions 32, e.g., 32-1, 32-2, 32-3 and 32-4. In the example illustration, each cell portion 32 corresponds to a particular geographic region or sub-region within the overall cell 30, where one or more such regions may overlap, at least to some extent. An antenna control unit, denoted in the diagram as a base station 34, controls distributed antennas or transmission points 36, e.g., 36-1, 36-2, 36-3 and 36-4, corresponding to cell portions 32-1, 32-2, 32-3 and 32-4. Thus, each cell portion 32 in this example may be understood as being associated with a different transmission point 36.

According to the teachings herein, one or more of the wireless devices 16 are configured to perform positioning operations that differentiate between cell portions 32. Correspondingly, one or more other “nodes” in the network 10 are configured to obtain and exchange positioning assistance data that includes cell portion information, for enabling positioning operations differentiated on a transmission-point basis. These other nodes comprise any one or more of: a wireless device 16, a base station 34, such as an eNodeB in an LTE example, a positioning node, such as an E-SMLC, an O&M node, an OSS node, or other node configured according to the teachings herein.

Before turning to example implementation details, it should be understood that the cell/cell-portion arrangement illustrated in FIG. 2 is a non-limiting example. The arrangement of cells 30 and cell portions 32 may vary in dependence on the type of network(s) involved and their underlying configurations. For example, a heterogeneous network may include one or more macro base stations providing macro or large-area cells, and one or more micro base stations providing smaller cells overlaying the macro cells.

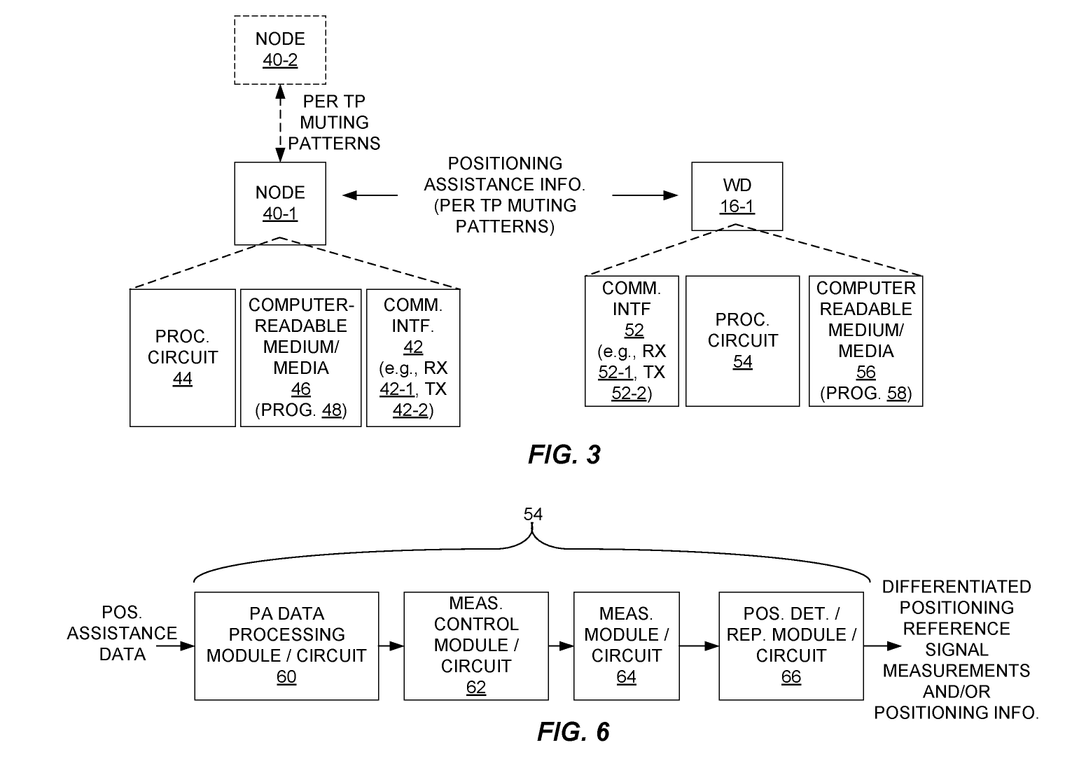

FIG. 3 illustrates an embodiment of a wireless device or WD 16-1 and an embodiment of a network node 40-1 that provides positioning assistance data to the wireless device 16-1, indicating the respective muting patterns of two or more transmission points 36 sharing the same cell identifier, for the transmission of PRS from the transmission points 36. The network node 40-1 may have direct knowledge of some or all of the muting patterns at issue, or it may receive such information from another node 40-2, which may or may not be of the same type as the network node 40-1.

By way of example, the network node 40-1 may be any one of: a second wireless device 16, a base station 34, a positioning node 24, or another network node. In the illustrated example, the network node 40-1 includes a communication interface 42, including receiver circuitry 42-1 and transmitter circuitry 42-2, and further includes a processing circuit 44. The processing circuit 44 includes or is associated with a computer-readable medium or media 46.

In one or more embodiments, the communication interface 42 includes more than one type of communication interface. Consider the case where the network node 40-1 comprises a base station 34. In such cases, the communication interface 42 includes a radio interface having receiver or RX circuitry 42-1 and transmitter or TX circuitry 42-2, for communicating with wireless devices 16, and further includes an inter-base-station communication interface for communicating with other base stations, along with a core network communication interface for communicating with one or more nodes in an associated core network—e.g., for communicating with packet gateways, mobility and authentication management servers, etc. In an LTE example, the communication interface 42 would include an “X2” interface to other eNodeBs, and one or more “S1” interfaces to the LTE core network, which is referred to as an Evolved Packet Core or EPC.

The processing circuit 44 comprises, for example, digital processing circuitry that is fixed or programmed to perform network-side processing as taught herein. In one embodiment, the processing circuit 44 comprises one or more microprocessors, Digital Signal Processors or DSPs, ASIC, FPGAs, etc. However implemented, such processing circuitry is configured according to the teachings herein. In one or more particular embodiments, the computer-readable medium 46 stores a computer program 48. Correspondingly, the processing circuit 44 is at least partly configured according to the teachings herein, based on its execution of the computer program instructions comprising the computer program 48.

With the above in mind, and using the reference number “40” as a general reference to a given node configured according to one aspect of the teachings herein, e.g., the network node 40-1 described above, a network node 40 according to one embodiment of the teachings herein is configured for operation in a wireless communication network 10 and it comprises a communication interface 42 and an associated processing circuit 44. The communication interface 42 is configured for directly or indirectly communicating with a wireless device 16 operating in the wireless communication network 10, and the processing circuit 44 is operative to enable positioning operations at the wireless device 16 on a per transmission-point basis.

The processing circuit 44 is operative in that regard based on being configured to determine muting patterns used in a cell 30 of the wireless communication network 10 that includes two or more geographically separated transmission points 36 sharing a common cell identity. Here, the muting patterns at issue are used by respective ones of the two or more transmission points 36 for transmitting positioning reference signals, and the processing circuit 44 is configured to generate positioning assistance data for the cell 30, for use by the wireless device 16. The positioning assistance data indicates the muting patterns used by the two or more transmission points 36 of the cell 30, and the processing circuit 44 is configured to send the positioning assistance data to the wireless device 16, to enable the wireless device 16 to make differentiated positioning reference signal measurements with respect to the two or more transmission points 36 of the cell 30.

In an example embodiment, the processing circuit 44 is configured to determine the muting patterns used by the transmission points 36 in the cell 30, by configuring the muting patterns to be used by the two or more transmission points 36 of the cell 30. In other words, the network node 40 knows the different muting patterns in use by the transmission points 36 within the cell 30 because it is the node that configures or otherwise controls those muting patterns.

In another example embodiment, the processing circuit 44 is configured to determine the muting patterns used in the cell 30, by receiving muting pattern information from another node in the wireless communication network 10. For example, it may be that the other node configures the muting patterns for the two or more transmission points 36 at issue in the cell 30, and provides that information to the network node 40. As noted, and by way of non-limiting example, the network node 40 comprises a node in the CN portion 14 of the wireless communication network 10, or the network node 40 comprises a node in the RAN portion 12 of the wireless communication network 10. In this latter case, the network node 40 may be a base station 34, for example, or may be another wireless device 16 operating within the network 10.

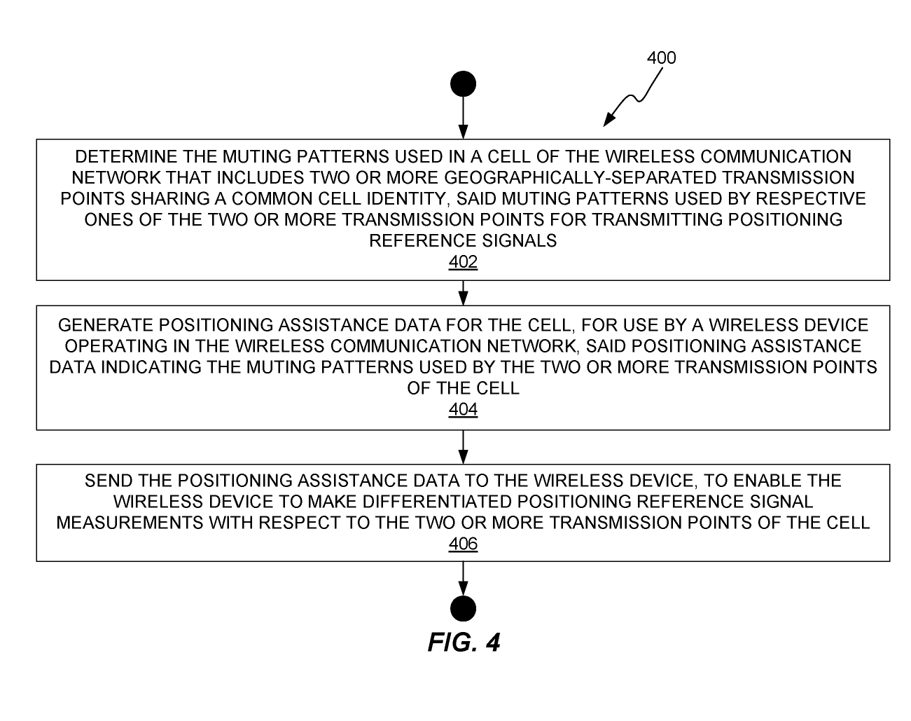

FIG. 4 illustrates a method 400 of processing at a network node 40, which may be arranged according to the example of FIG. 3, or which may adopt another arrangement of communications and processing circuitry configured to carry out the method 400. In either case, the method 400 relates to operation at a node 40 that is configured for operation in a wireless communication network 10 and it includes determining (Block 402) the muting patterns used in a cell 30 of the wireless communication network 10 that includes two or more geographically-separated transmission points 36. Here, the transmission points 36 share a common cell identity and the muting patterns in question are used by respective ones of the two or more transmission points 36 for transmitting positioning reference signals. The network node 40 determines the muting patterns based on, e.g., provisioned information known to it, control data generated by it, or information received from another node.

The method 400 includes generating (Block 404) positioning assistance data for the cell 30, for use by a wireless device 16 operating in the wireless communication network 10. The positioning assistance data indicates the muting patterns used by the two or more transmission points 36 of the cell 30 and the method 400 further includes sending (Block 406) the positioning assistance data to the wireless device 16, thereby enabling the wireless device 16 to make differentiated positioning reference signal measurements with respect to the two or more transmission points 36 of the cell 30.

In other words, because the different transmission points 36 share a common PCI or other such identifier, and because all of the PRSs transmitted by them are therefore associated with the same identifier, the wireless device 16 would be unable to distinguish between the PRS measurements made for PRS from one transmission point 36 and the PRS measurements made for PRS from another transmission point, absent knowledge of the respective muting patterns used by the different transmission points 36 for their PRS transmissions. The positioning assistance data contemplated herein provides wireless devices 16 with such knowledge, and advantageously improves or otherwise enhances positioning measurements made by wireless devices 16 operating in areas where more than one transmission point 36 uses the same cell identifier. As a particular but non-limiting example, the teachings herein improve positioning in heterogeneous network deployments using Remote Radio Heads, or RRHs, by enabling wireless devices 16 to differentiate PRS measurements with respect to the individual RRHs.

Complementing the above teachings regarding the example node 40, the wireless device 16 may be essentially any apparatus that is configured for wireless communication in the network 10, and is further configured for positioning-related operations according to the teachings herein. Non-limiting examples of the wireless device 16 include a cellular radiotelephone, e.g., a smartphone, feature phone, etc., a tablet or laptop computer, a network adaptor, card, modem or other such interface device.

In the 3GPP context, the wireless device 16-1 is referred to as a UE and it will be understood as including a communication interface 52, including radiofrequency receiver or RX circuitry 52-1 and radiofrequency transmitter or TX circuitry 52-2. This circuitry and the overall device 16-1 are configured for network communications according to the applicable network communication protocols, and may be further configured for Device-to-Device, D2D, communications, wherein signaling is exchanged with one or more other wireless devices 16.

The communication interface 52 may comprise a mix of analog and digital circuits. For example, the RX circuitry 52-1 in one or more embodiments comprises a receiver front-end circuit that is not explicitly shown in FIG. 3. The front-end circuit generates one or more streams of digital signal samples corresponding to antenna-received signals, and further includes one or more receiver processing circuits—e.g., baseband digital processing circuitry and associated buffer memory—which operate on the digital samples. Example operations include linearization or other channel compensation, possibly with interference suppression, and symbol demodulation/detection and decoding, for recovering transmitted information.

The wireless device 16-1 further includes a processing circuit 54 that is operatively associated with the communication interface 52. The processing circuit 54 includes or is associated with a computer-readable medium or media 56. The computer-readable medium 56 comprises, for example, a mix of volatile, working memory and non-volatile configuration and program memory. Non-limiting examples of the former include Static RAM or SRAM, while non-limiting examples of the latter include FLASH, EEPROM, and SSD storage.

The processing circuit 54 provides, for example, digital baseband processing for signals transmitted and received through the communication interface 52. The processing circuit 54 in this regard comprises digital processing circuitry and may be implemented as one or more microprocessors, DSPs, ASICs, FPGAs, etc. More generally, the processing circuit 54 may be implemented using fixed circuitry or programmed circuitry, or a mix of both. In an example embodiment, the computer-readable medium 56 stores a computer program 58 and the processing circuit 54 is at least partly configured according to the teachings herein, based on its execution of the computer program instructions comprising the computer program 58.

However, implemented, a wireless device 16 configured for operation in a wireless communication network 10 according to an embodiment contemplated herein includes a communication interface 52 that is configured to receive signals from a wireless communication network 10 and to send signals to the wireless communication network 10. The wireless device 16 further includes a processing circuit 54 that is operatively associated with the communication interface 52 and is configured to receive positioning assistance data for a cell 30 of the wireless communication network 10 that includes two or more geographically separated transmission points 36 sharing a common cell identity.

The positioning assistance data indicates muting patterns used by respective ones of the two or more transmission points 36 for transmitting PRS, and the processing circuit 54 is configured to process the positioning assistance data to determine the muting patterns, e.g., extract them from the received signaling, and to measure PRS from each of the two or more transmission points 36 according to the muting patterns, to obtain PRS measurements that are differentiated with respect to the two or more transmission points 36. Correspondingly, the processing circuit 54 is configured to perform at least one of: determine positioning information for the wireless device 16 based on relating the differentiated PRS measurements; and report the differentiated PRS measurements to the wireless communication network 10.

In one or more embodiments, the processing circuit 54 is configured to measure the PRS by performing signal-timing measurements with respect to the PRS transmitted from each of the two or more transmission points 36. In the same or in one or more other embodiments, the processing circuit 54 is configured to report the differentiated PRS to the wireless communication network 10, by associating or reporting the PRS measurements on a per transmission-point basis. In an example configuration, the processing circuit 54 relates the differentiated PRS measurements by determining timing differences with respect to the differentiated PRS measurements.

That is, the processing circuit 54 determines one or more timing differences between the PRS received from different ones of the transmission points 36 sharing the same cell identity. For example, the processing circuit 54 makes OTDOA measurements with respect to the PRS received from respective ones of the two or more transmission points 36, in accordance with the muting patterns. Here, “in accordance with” denotes differentiation by the wireless device 16 with respect to the different transmission points 36, inasmuch as the different muting patterns indicate to the wireless device 16 the different time and/or frequency resources used by the different transmission points 36 for their respective PRS transmissions. Thus, the wireless device 16 is able to make separate PRS measurements for each transmission point 36 and to avoid inappropriately averaging or mixing measurement values made for one transmission point 36 with those made for another transmission point 36.

Also of note, the cell 30 in question may be a serving cell of the wireless device 16, or may be a neighboring cell of a serving cell of the wireless device 16, or may be a reference cell for positioning. It will be appreciated that the wireless device 16 may receive positioning assistance data for both serving and neighboring cells, and may receive different positioning assistance data at different times, e.g., responsive to mobility of the device 16, etc.

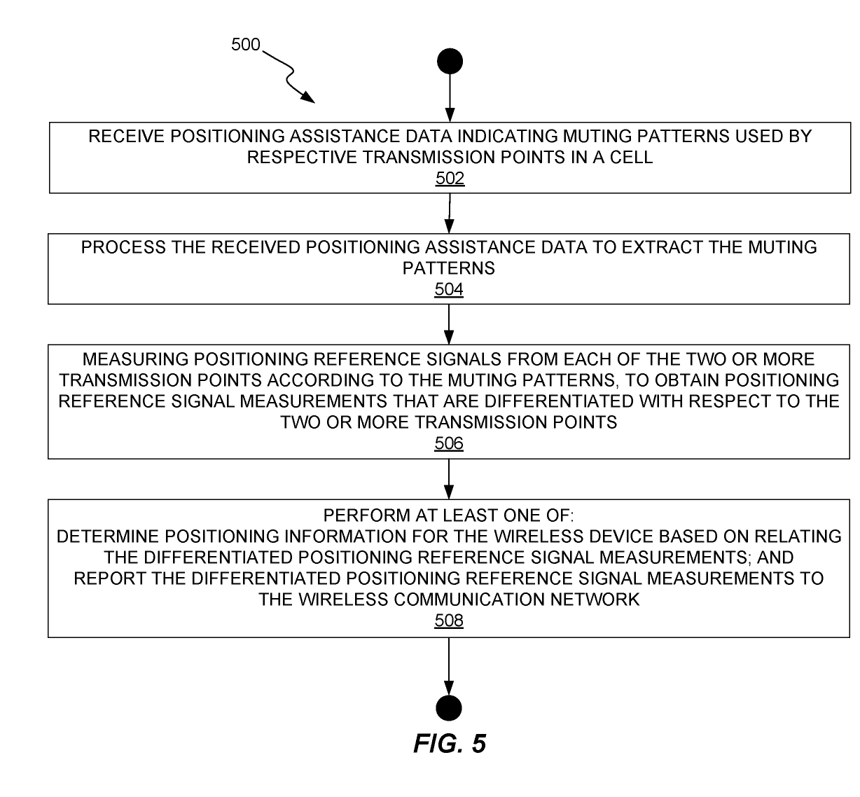

FIG. 5 illustrates a method 500, such as may be performed by the wireless device 16 of FIG. 3, or such as may be performed by a wireless device having a different arrangement of circuitry. The method 500 includes the wireless device 16 in question receiving (Block 502) positioning assistance data for a cell 30 of the wireless communication network 10 that includes two or more geographically separated transmission points 36 sharing a common cell identity. The positioning assistance data indicates muting patterns used by respective ones of the two or more transmission points 36 for transmitting PRS.

Correspondingly, the method 500 includes processing (Block 504) the positioning assistance data to extract the muting patterns, and measuring (Block 506) PRS from each of the two or more transmission points 36 according to the muting patterns. Here, “according to the muting patterns” connotes the fact that the wireless device 16 keeps track of which of its PRS measurements correspond to which ones of the muting patterns. Of course, the wireless device 16 does not need to know which transmission point 36 is transmitting PRS at any particular time, it simply needs to segregate the PRS measurements it makes for one of the muting pattern from the PRS measurements its makes for another one of the muting patterns.

By maintaining this differentiation of PRS measurements with respect to the different muting patterns, the wireless device 16 obtain PRS measurements that are differentiated with respect to the two or more transmission points 36. The method 500 correspondingly includes performing (Block 508) at least one of: determining positioning information for the wireless device 16 based on relating the differentiated PRS measurements; and reporting the differentiated PRS measurements to the wireless communication network 10.

In an example of “relating” the differentiated PRS measurements, the wireless device 16 determines signal timing differences or other differences, between the PRS received in accordance with one of the muting patterns and the PRS received in accordance with another one of the muting patterns. Of course, the wireless device 16 may relate the PRS measurements for more than two muting patterns corresponding to more than two transmission points 36 sharing the same cell identifier.

FIG. 6 illustrates an example arrangement for the processing circuit 54 of the example wireless device 16-1. In particular, the processing circuit 54 may be viewed as comprising or implementing a number of processing modules or functional circuits, including a positioning assistance, PA, data processing module 60 that is configured to process positioning assistance data received by the wireless device 16, to determine per transmission point muting patterns applicable to the cell 30 in question.

A measurement control module 62 uses the per transmission point muting patterns to configure a measurement module 64, to make differentiated PRS measurements. That is, the measurement control module 62 configures the measurement module 64 to make PRS measurements at the relevant positioning occasions or other PRS transmission instances, and to keep the corresponding raw and/or processed PRS measurements segregated for each of the respective muting patterns. Correspondingly, a position determination/reporting module 66 uses the differentiated PRS measurements to determine position information for the wireless device 16, or it reports the differentiated PRS measurements, or it does both.

Advantageously, knowledge of the respective muting patterns used by multiple transmission points 36 sharing the same cell identifier, e.g., having a common Physical Cell Identity or PCI, improves or otherwise enhances positioning-related measurements at the wireless device 16-1, by allowing the wireless device 16-1 to relate particular ones of those measurements to particular ones of the transmission points 36. In turn, such relations provide more precise geographic information for the wireless device 16-1. For example, the wireless device 16-1 and/or another node 40 determines the closest transmission point 36 to the wireless device 16 and/or determines the position of the wireless device 16-1 in relation to two or more of the transmission points 36 sharing the same cell identifier.

The above advantages and the broader teachings herein are not limited to LTE, and may be applied to any RAN or RANs of the same or differing Radio Access Technologies, RATs. Further, the teachings herein apply irrespective of whether or not the wireless communication network 10 and wireless devices 16 use Carrier Aggregation, CA. Non-limiting examples of RATs to which the teachings herein are readily applied include LTE-Advanced, UMTS, HSPA, GSM, cdma2000, WiMAX, and WiFi.

Also as noted in the above examples, the network node 40 that provides positioning assistance data to a wireless device 16 may be another wireless device 16, e.g., one that receives the positioning assistance data from the wireless communication network 10 and forwards it to the wireless device 16. Alternatively, the network node 40 is a network node residing within the RAN portion 12 of the wireless communication network 10, e.g., a base station 34, or the network node 40 resides within the CN 14 portion of the wireless communication network 10, and comprises an MME, a S-GW, an O&M node, an OSS node, or a positioning node, such as an E-SMLC.

The positioning assistance data itself may take many forms and various signaling mechanisms and formats are contemplated herein, but the provided examples should be understood as non-limiting. The positioning assistance data comprises, for example, an ordered list identifying cell portions 32 and/or transmission points 36 along with indications of the respective muting patterns, or it may simply indicate the respective muting patterns that are in use for a given cell 30. In this latter case, the muting patterns may be expressly indicated or may be identified using indexes or other values that the wireless device 16 uses to identify which muting patterns are in use.

The data may also comprise data describing the one or more cells 30 associated with the transmission points 36 in question. For example, more than one cell 30 may share a transmission point 36, in which case the transmission point 36 transmits PRS under different cell identifiers at different times. However, it will be understood that with respect to any of the cells 30 sharing the transmission point 36, the transmission point 36 uses an assigned muting pattern for transmitting PRS for any one of the cell identifiers. Cells may be identified using PCI or Enhanced Cell Global Identities, ECGI. In one example, the data include ECGI, depending on the inclusion of at least one cell portion 32 associated with the cell, e.g., do not include ECGI when at least one cell portion 32 of the cell 30 is included and include otherwise. In another example, the data may comprise an implicit or explicit indication that there is one or more transmission points 36 associated with a given cell 30 identified in the positioning assistance data. For example, not including the ECGI of the cell 30 serves as an implicit indication to the wireless device 16 that the cell 30 uses multiple transmission points 36 sharing the same cell identity.

In other variations, the network 10 sends data to a wireless device 16 indicating that it should obtain positioning assistance data—e.g., that it should request muting pattern information for the multiple transmission points 36 associated with a given cell 30. In one such example, the wireless device uses the LTE Positioning Protocol, LPP, to request such information from an E-SMLC or other positioning node in the network 10.

Still further, there may be predefined relationships that govern the different muting patterns used by the multiple transmission points 36 in a given cell 30 and the wireless device 16 may be preconfigured with such information, or may receive such information from the network 10. In such cases, the positioning assistance data may simply indicate the number of transmission points 36 at issue, and the wireless device 16 may determine the respective muting patterns from an ordered listing or other data structure that indicates the different subframes or positioning occasions used by the respective transmission points 36. Again, the wireless device 16 does not necessarily need to know which particular one of the multiple transmission points 36 is using which particular one of the muting patterns; it only needs to know that it should differentiate the measurements it makes on PRS for the involved cell 30, based on the two or more muting patterns at issue.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-22. (canceled)

23. A method at a wireless device configured for operation in a wireless communication network, said method comprising:
receiving positioning assistance data for a cell of the wireless communication network that includes two or more geographically-separated transmission points sharing a common cell identity, said positioning assistance data indicating muting patterns used by respective ones of the two or more transmission points for transmitting positioning reference signals;
processing the positioning assistance data to extract the muting patterns;
measuring positioning reference signals from each of the two or more transmission points according to the muting patterns, to obtain positioning reference signal measurements that are differentiated with respect to the two or more transmission points; and
performing at least one of:
determining positioning information for the wireless device based on relating the differentiated positioning reference signal measurements; and
reporting the differentiated positioning reference signal measurements to the wireless communication network.

24. The method of claim 23, wherein measuring the positioning reference signals comprises performing signal timing measurements with respect to the positioning reference signals transmitted from each of the two or more transmission points.

25. The method of claim 23, wherein reporting the differentiated positioning reference signal measurements to the wireless communication network comprises associating or reporting the positioning reference signal measurements on a per transmission-point basis.

26. The method of claim 23, wherein determining positioning information based on relating the differentiated positioning reference signal measurements comprises determining timing differences with respect to the differentiated positioning reference signal measurements.

27. The method of claim 23, wherein the cell is one of a serving cell of the wireless device, and a neighboring cell of a serving cell of the wireless device.

28. The method of claim 23, wherein determining the positioning information for the wireless device based on relating the differentiated positioning reference signal measurements comprises performing Observed Time Difference of Arrival (OTDOA) measurements with respect to the positioning reference signals received from respective ones of the two or more transmission points, in accordance with the muting patterns.

29. A wireless device configured for operation in a wireless communication network and comprising:
a communication interface configured to receive signals from the wireless communication network and to send signals to the wireless communication network; and
a processing circuit operatively associated with the communication interface and configured to:
receive positioning assistance data for a cell of the wireless communication network that includes two or more geographically-separated transmission points sharing a common cell identity, said positioning assistance data indicating muting patterns used by respective ones of the two or more transmission points for transmitting positioning reference signals;
process the positioning assistance data to extract the muting patterns;
measure positioning reference signals from each of the two or more transmission points according to the muting patterns, to obtain positioning reference signal measurements that are differentiated with respect to the two or more transmission points; and
perform at least one of:
determine positioning information for the wireless device based on relating the differentiated positioning reference signal measurements; and
report the differentiated positioning reference signal measurements to the wireless communication network.

30. The wireless device of claim 29, wherein the processing circuit is configured to measure the positioning reference signals by performing signal timing measurements with respect to the positioning reference signals transmitted from each of the two or more transmission points.

31. The wireless device of claim 29, wherein the processing circuit is configured to report the differentiated positioning reference signal measurements to the wireless communication network by associating or reporting the positioning reference signal measurements on a per transmission-point basis.

32. The wireless device of claim 29, wherein the processing circuit is configured to relate the differentiated positioning reference signal measurements by determining timing differences with respect to the differentiated positioning reference signal measurements.

33. The wireless device of claim 29, wherein the cell is one of a serving cell of the wireless device, and a neighboring cell of a serving cell of the wireless device.

34. The wireless device of claim 29, wherein the processing circuit is configured to relate the differentiated positioning reference signal measurements by performing Observed Time Difference of Arrival (OTDOA) measurements with respect to the positioning reference signals received from respective ones of the two or more transmission points, in accordance with the muting patterns.

35. A method of operation at a node configured for operation in a wireless communication network, said method comprising:
determining muting patterns used in a cell of the wireless communication network that includes two or more geographically-separated transmission points sharing a common cell identity, said muting patterns used by respective ones of the two or more transmission points for transmitting positioning reference signals;
generating positioning assistance data for the cell, for use by a wireless device operating in the wireless communication network, said positioning assistance data indicating the muting patterns used by the two or more transmission points of the cell; and
sending the positioning assistance data to the wireless device, thereby enabling the wireless device to make differentiated positioning reference signal measurements with respect to the two or more transmission points of the cell.

36. The method of claim 35, wherein determining the muting patterns used in the cell of the wireless communication network comprises configuring the muting patterns to be used by the two or more transmission points of the cell.

37. The method of claim 35, wherein determining the muting patterns used in the cell of the wireless communication network comprises receiving muting pattern information from another node in the case that another node in the wireless communication network configures the muting patterns for the two or more transmission points of the cell.

38. The method of claim 35, wherein the node comprises a network node in a Core Network (CN) portion of the wireless communication network.

39. The method of claim 35, wherein the node comprises a network node in a Radio Access Network (RAN) portion of the wireless communication network.

40. A node configured for operation in a wireless communication network, said node comprising:
a communication interface configured for directly or indirectly communicating with a wireless device operating in the wireless communication network;
a processing circuit that is operatively associated with the communication interface and is operative to enable positioning operations at the wireless device on a per transmission-point basis, based on being configured to:
determine muting patterns used in a cell of the wireless communication network that includes two or more geographically-separated transmission points sharing a common cell identity, said muting patterns used by respective ones of the two or more transmission points for transmitting positioning reference signals;
generate positioning assistance data for the cell, for use by the wireless device, said positioning assistance data indicating the muting patterns used by the two or more transmission points of the cell; and
send the positioning assistance data to the wireless device, thereby enabling the wireless device to make differentiated positioning reference signal measurements with respect to the two or more transmission points of the cell.

41. The node of claim 40, wherein the processing circuit is configured to determine the muting patterns used in the cell of the wireless communication network by configuring the muting patterns to be used by the two or more transmission points of the cell.

42. The node of claim 40, wherein the processing circuit is configured to determine the muting patterns used in the cell of the wireless communication network by receiving muting pattern information from another node in the case that another node in the wireless communication network configures the muting patterns for the two or more transmission points of the cell.

43. The node of claim 40, wherein the node comprises a node in a Core Network (CN) portion of the wireless communication network.

44. The node of claim 40, wherein the node comprises a node in a Radio Access Network (RAN) portion of the wireless communication network.
